(19) United States
(12) Patent Application Publication
(10) Pub. No.: US 2018/0093433 A1
(43) Pub. Date: Apr. 5, 2018

(54) FIBER APPLICATION HEAD WITH AN INFRARED HEATING SYSTEM

(71) Applicant: CORIOLIS COMPOSITES, Lyon (FR)

(72) Inventors: Johannes Treiber, Lauingen (DE); Olivier Leborgne, Lorient (FR)

(73) Assignee: CORIOLIS COMPOSITES, Lyon (FR)

(21) Appl. No.: 15/558,821

(22) PCT Filed: Mar. 10, 2016
(86) PCT No.: PCT/FR2016/000043

§ 371 Date: Sep. 15, 2017

(30) Foreign Application Priority Data
Mar. 16, 2015 (FR) 15 00553

(51) Int. Cl. B29C 70/38

(52) U.S. Cl. CPC B29C 70/384; B29K 2105/08

(57) ABSTRACT

A fiber application head, comprising a roller for applying a band formed from one or more fibers onto an application surface, a main guide system for guiding at least one fiber towards said roller, and a heating system capable of emitting thermal radiation in the direction of the band, just prior to the application thereof. The heating system comprises at least one first infrared lamp capable of heating the band coming out of the main guide system, and at least one second infrared lamp capable of heating the surface upstream from the roller, the head further comprising a secondary guide system capable of guiding the band between the main guide system and the roller while enabling the band to be heated by the first lamp.

### RELATED CASES

The present application is a National Phase entry of PCT Application No. PCT/FR2016/000043, filed Mar. 10, 2016, which claims priority from FR Patent Application No. 15 00553, filed Mar. 16, 2015, which applications are hereby incorporated by reference in their entireties.

### TECHNICAL FIELD

The present invention relates to a fiber application head for a fiber application machine for the production of composite material parts, and more particularly to a so-called fiber placement head equipped with an infrared type heating system. The present invention also relates to a method for manufacturing composite material parts by means of a corresponding application head.

### BACKGROUND ART

There are known fiber application machines, commonly called fiber placement machines, for the application by contact onto a laying up tool, such as a male or female mold, of a wide band formed of several continuous flat fibers, of ribbon type, dry or impregnated with thermosetting or thermoplastic resin, in particular carbon fibers consisting of a multitude of threads or carbon filaments.

These machines are used to produce preforms formed of several superposed plies, each ply being formed by laying up onto the mold one or more bands side by side. In the case of a layup of fibers pre-impregnated with thermoplastic or thermosetting resin, typically of a quantity of at least 40% in weight, the pre-impregnated preform obtained after laying up is hardened or polymerized by passing it through an oven to obtain a composite material part. In the case of so-called dry fibers, which are not pre-impregnated with resins, the fibers comprise a reduced quantity of so-called bonding resin, also called a binder, generally a thermoplastic resin, in a quantity of less than or equal to 5% in weight, to give a tackiness to the fibers during laying up. After laying up, the so-called dry preform is subjected to a resin injection or infusion operation before the curing step.

These machines, such as described in the patent document WO2006/092514, typically comprise a fiber application head, a system for moving said head, fiber storage means, and fiber conveying means for conveying the fibers from said storage means to the head. The head typically comprises an application roller, also called a compacting roller, intended to come into contact with the mold to apply the band, and means for guiding the fibers on said application roller. The head generally further comprises a heating system for heating the fibers. The compacting roller presses the band of fibers against the application surface of the mold, or against the band(s) of fibers previously applied, in order to facilitate the adhesion of the applied bands to each other, as well as to progressively discharge the air trapped between the laid bands. The heating system ensures the heating of the bands of fibers to be applied, and/or of the mold or bands already applied upstream of the compacting roller, just before the compacting of the band, in order to at least soften the pre-impregnation resin or bonding resin, and thus promote adhesion of the bands to one another.

In the case of thermosetting resins, the pre-impregnated fibers are simply heated to soften them, typically at temperatures in the order of 40° C. The heating system typically comprises an infrared heating system comprising one or more infrared lamps.

In the case of thermoplastic resins, the pre-impregnated fibers must be heated at higher temperatures, at least up to the resin melting temperature, being of the order of 200° C. for nylon type resins, and up to about 400° C. for PEEK type resins.

To achieve these higher temperatures, hot air torch systems, and more recently laser type heating systems have been proposed. Hot air torches are an economical solution, but the heating area and the heating temperature are difficult to regulate accurately. The laser heating systems are more precise in terms of the definition of the area to be heated and heating temperature. These laser heating systems significantly increase the total cost of the fiber placement cell, and present significant constraints in terms of safety. Furthermore, the laser beam is generally conveyed from the laser source up to the laser optic carried by the head by means of an optic fiber. This optic fiber system may be incompatible with certain movement systems of the fiber placement machine and/or with the interchangeable head concepts, in which the fiber spools can be mounted.

### SUMMARY OF THE INVENTION

Embodiments of the invention propose a solution to overcome the aforementioned drawbacks, and in particular provide a heating system for a fiber placement machine which is simple in design and implementation and which enables the use of dry fibers with a thermoplastic binder and/or fibers pre-impregnated with a thermoplastic resin.

To this end, embodiments of the present invention propose a fiber application head for the production of composite material parts, comprising an application roller for the application of a band formed of one or more fibers onto an application surface, a main guide system for guiding at least one fiber towards said application roller, and a heating system capable of emitting thermal radiation in the direction of the band, just before its application by the application roller, characterized in that the heating system comprises at least one first infrared lamp capable of heating the band between its outlet from the main guide system and the contact area between the application roller and the application surface, and at least one second infrared lamp capable of heating the application surface and/or one or more previously applied bands, upstream of the roller, in relation to the direction of the advancement of the application head, the head further comprising a secondary guide system capable of guiding the band between the main guide system and the application roller while enabling the band to be heated by the first lamp between the main guide system and the application roller.

According to the invention, the heating system is an infrared lamp type system, including a lamp for heating the layup surface and/or fibers previously laid, and an infrared lamp which is oriented towards the band at the outlet of the main guide system, combined with a secondary guide system adapted to enable sufficient heating of the band for its layup, while ensuring correct guiding of the band towards the roller.

Such a heating system can advantageously be used for the laying up of dry fibers or fibers pre-impregnated with thermoplastic resin. Such a heating system is simple in design and is fully mounted on the head, without any remote parts such as for a laser type system. Such a heating system can in particular be advantageously used for interchangeable application heads, and/or with heads associated to particular displacement systems that do not enable the connection of the elements of the heating system mounted on the head to other elements remote from the head.

According to one embodiment, the secondary guide system is capable of laterally guiding the band at the outlet of the main guide system, and thus preventing lateral movement of the band in a direction parallel to the axis of rotation of the roller, preferably capable of laterally guiding each fiber of said band.

According to one embodiment, the guide system comprises a comb whose fingers extend substantially perpendicularly to the axis of rotation of the application roller, preferably from the outlet of the main guide system. According to one embodiment, each fiber of the band is capable of being guided between two fingers of the comb. According to another embodiment, the comb comprises only two fingers between which the band is guided.

According to one embodiment, the secondary guide system is capable of keeping the band remote from the first lamp, in order to avoid contact of the band with the first lamp, in particular at the end of laying up the fibers after a cutting operation. According to one embodiment, the secondary guide system comprises at least one rod positioned between the first lamp and the application roller, substantially parallel to the axis of the roller, the band passing between the rod and the application roller.

According to one embodiment, each finger of the comb is in contact with the rod, in particular when the heating system is in an active position. According to one embodiment, the rod is hollow and is cooled by a fluid circulating in the rod, in particular an air flow.

According to one embodiment, the thermal radiation of each first lamp is centered towards the application roller, and the thermal radiation of the second lamp is centered towards the application surface upstream of the application roller, said lamps being for example equipped with a reflector, in particular in the form of a reflective coating, in order to direct and concentrate the radiation.

According to one embodiment, the head constitutes a fiber placement head comprising a cutting means and a feeding means, and possibly a blocking means for the fibers.

Embodiments of the invention also concern a method for producing a composite material part comprising the application of continuous fibers onto an application surface in order to form a preform comprising several plies of fibers superimposed in different orientations, each ply being made by applying one or more bands along one orientation, each band being formed of one or more fibers, characterized in that the application of fibers is carried out by means of a fiber application head such as defined previously, by relative movement of the application head in relation to the layup surface along different layup trajectories.

The process according to embodiments of the invention is particularly advantageous in the case of dry preforms made from dry fibers provided with a binder and/or thermoplastic preforms made from fibers pre-impregnated with thermoplastic resin. In the case of a dry preform, the process further comprises a step of the impregnation of the resin in the dry preform, by adding one or more impregnation resins by infusion or injection to the dry preform, and a curing step to obtain a composite material part. In the case of a thermoplastic preform, the preform may possibly be subjected to an additional consolidation step in order to obtain a final part made of composite material.

### BRIEF DESCRIPTION OF THE DRAWINGS

The invention will be better understood, and the other objectives, details, characteristics and advantages will appear more clearly during the following detailed explanatory description of two specific embodiments currently preferred from the invention, with reference to the appended schematic drawings, in which:

FIG. 1 is a partial schematic side view of a fiber placement head equipped with a heating system according to one embodiment of the invention;

FIG. 2 is a partial schematic sectional view of the head of FIG. 1 illustrating the heating system;

FIGS. 3A and 3B are two perspective views of the heating system mounted on the assembly parts of the compacting roller;

FIG. 4 is a partial side view of the head with the heating system in the remote position;

FIG. 5 is a view similar to that of FIG. 2 illustrating a head according to an alternative embodiment, comprising a lateral secondary guide system; and,

FIG. 6 is a partial perspective view of the head of FIG. 5, the heating system being in the remote position.

### DETAILED DESCRIPTION OF THE DRAWINGS

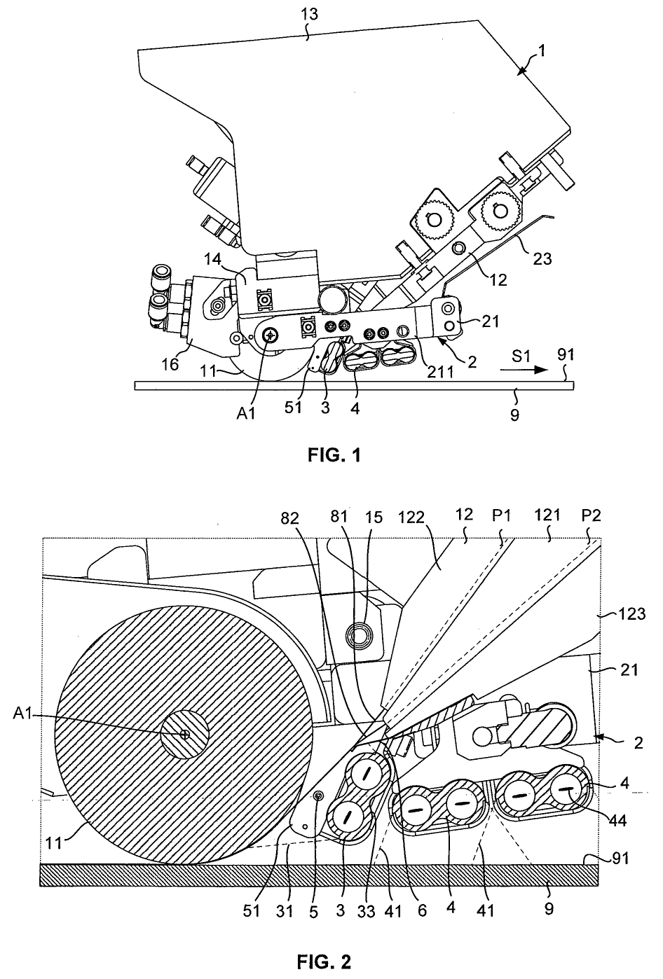

FIGS. 1 to 4 illustrate a fiber placement head 1 according to embodiments of the invention equipped with a heating system 2, enabling automatic layup by contact onto the application surface 91 of a mold 9 of bands formed of several fibers, by relative movement of the head in relation to the mold via a displacement system.

The head 1 comprises a compacting roller 11, a main guide system 12 for guiding the fibers towards the roller in the form of two layers of fibers, in order to form a band of fibers in which the fibers are positioned substantially edge-to-edge. With reference to FIG. 2, the head comprises for example a main guide system such as described in the aforementioned patent document, comprising first guide channels and second guide channels in which pass respectively the first fibers 81 of the first layer and the second fibers 82 of the second layer. The first channels and the second channels are positioned in staggered rows, along two guide planes, shown schematically under the references P1 and P2, approaching each other from upstream to downstream, so that the fibers 81, 82 of the two layers are positioned substantially edge-to-edge at the level of the compacting roller. These guide channels are formed for example at the assembly interface of a central part 121, in the form of a wedge, and two lateral plates 122, 123.

The head comprises for example a support structure 13 on which the main guide system 12 is mounted and through which the head can be assembled to a displacement system (not shown) which is capable of moving the head in at least three perpendicular directions to one another. The roller is mounted free to rotate around an axis A1 of rotation on two assembly parts 14, through which the roller is mounted in a removable manner on the support structure 13. The displacement system comprises for example, a robot comprising a wrist or multi-articulated arm at the end of which said head is mounted. In a variant, the head is fixed and the mold is capable of being moved in relation to the head to perform the laying up operations. The fibers are conveyed from the storage means (not shown) to the head via the conveying means (not shown). The fiber storage means may comprise a creel in the case of fibers packaged in the form of spools. The conveying means may be formed of flexible tubes, each tube receiving one fiber in its internal passage.

In a manner known per se, the head comprises cutting means for individually cutting each fiber passing through the main guide system, blocking means for individually blocking each fiber that has just been cut, and feeding or driving means for individually feeding up to the roller each fiber that has just been cut, in order to be able to stop and resume the application of a fiber at any time, as well as to choose the width of the band. These various means (not shown) are described particularly in the aforementioned patent document.

The head is for example designed to accommodate sixteen fibers and to allow enable the application of a band of sixteen fibers, for example each 6.35 mm (¼ inch) wide.

The heating system 2 is positioned upstream of the roller in relation to the direction of advancement of the head during laying-up, illustrated by the arrow referenced S1. It comprises a first infrared radiation lamp 3, called infrared lamp, for heating the fibers coming out of the main guide system 12, and two second infrared lamps 4, positioned upstream of the first infrared lamp, for heating, upstream of the compacting roller in relation to the direction of advancement of the head, the layup surface and/or the fibers previously laid.

The lamps 3, 4 are mounted on a support system 21 which is assembled to the head, and are positioned parallel to the axis A1 of the compacting roller, so that the radiation 31 of the first lamp 3 is directed towards the roller, while the radiations 41 of the second lamps 4 are directed towards the application surface. Each lamp extends over the entire length of the compacting roller, in such a manner so that a band of sixteen fibers can be heated here. Infrared lamps here are double-tube or twin-tube lamps. For each lamp, the twin tubes are equipped on one side with a reflective coating 33 in order to concentrate the radiation, to form a barrier screen and thus limit the heating of the main guide system and of the support system 21.

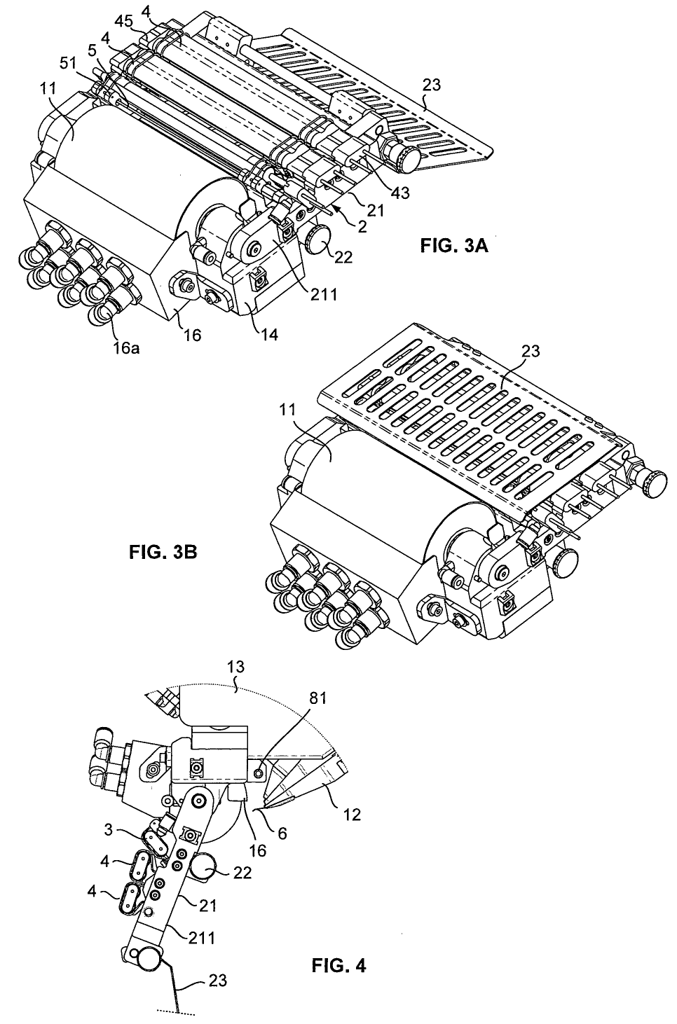

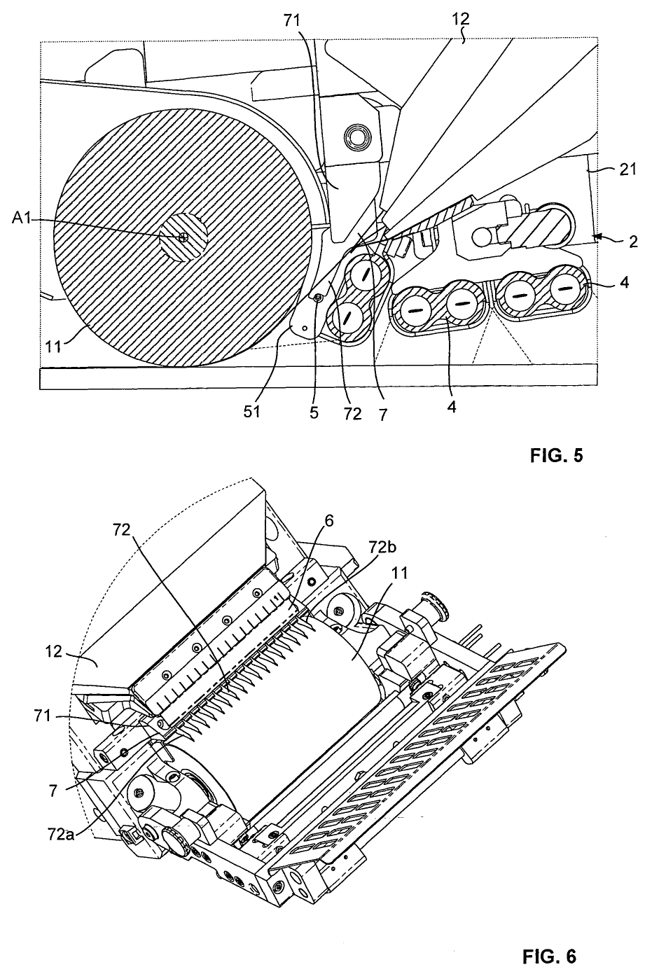

The support system 21 comprises two arms 211 between which the lamps 3, 4 are mounted, the arms being assembled by their first end to the assembly parts 14. The arms are preferably mounted to rotate and can be moved between an active lay-up position as illustrated in FIGS. 1 and 2, and a remote position, called maintenance position, illustrated in FIG. 4, in which the heating system 2 is remote from the main guide system 12 to allow access to the latter and to carry out maintenance operations. The blocking means makes it possible to keep the heating system in the active position, these means comprising for example for each arm a rod maneuvered by a button 22 and capable of being inserted into a suitable recess 15 of the support structure 13. A plate or protective grill 23 is mounted to the second ends of the arms 211, and can be moved from a retracted position illustrated in FIG. 1, to the maintenance position illustrated in FIG. 3B. The grill is brought into the retracted position during the laying up operations and is brought into the maintenance position above the lamps, in order to protect the lamps during maintenance operations, as well as the operators to reduce the risk of burns.

A secondary guide system is positioned between the first lamp and the roller, and comprises a rod 5 extending parallel to the axis of the roller and mounted between the two arms 211 via two flanges 51. The thin section of the rod forms a negligible screen to the radiation of the first lamp. The rod is advantageously a hollow rod and is cooled by a flow of air circulating in the rod. During layup, the fibers pass between the roller 11 and the rod 5. The rod thus prevents any contact between the fiber and the first lamp 3, in particular after a cutting operation, when the ends of the fibers leave the main guide system.

The main guide system comprises a deflector 6, positioned above the first lamp 3, and is formed of a flexible blade. This deflector makes it possible to separate from the first lamp the fibers coming out of the channels and to direct them between the roller and the rod, particularly during fiber feeding operations after a cutting operation, when the ends of the fibers come out of the channels. The deflector is here mounted directly on the main guide system. In a variant, this deflector 6 is mounted on the support system 21 of the heating system.

According to another variant, one or more other rods are provided upstream and/or downstream of the aforementioned rod 5.

According to another variant, the rod or the rods 5, as well as possibly the deflector 6, are replaced by a grill preventing the passage of fibers between the grill and the first lamp 3 while enabling the heating of the fibers coming out of the main guide system through the radiation emitted by the first lamp.

The fiber placement head advantageously comprises a compacting roller 11 capable of conforming to the application surface, in particular to convex and/or concave application surfaces in order to ensure a substantially uniform compaction over the entire width of the band. The roller is for example a compacting roller of so-called flexible material, which is elastically deformable, such as an elastomer. The roller is cooled by a cooling system 16 comprising a deflector or nozzle supplied with air through pipes (not shown) connected to the nozzle via connectors 16a, the nozzle covering the roller over a large sector, of more than 180°, opposite to the application surface.

In the example illustrated, each lamp 3, 4 comprises two twin quartz glass tubes, equipped on one side with an electrical connection system 43 for the electrical connection of the filaments 44 of the tubes, the filaments being linked together electrically at the other side by a connector 45. By way of example, the heating system comprises infrared lamps or emitters marketed under the tradename Golden 8 by the company Heraeus Noblelight.

During laying up, the heating system is in the active position, the first lamp 3 heats the fibers to be laid coming out of the main guide system, before their application onto the application surface by the roller, and the second lamps 4 heat the application surface and/or the fibers of the preceding ply or plies, in order to ensure the bond between the fibers to be laid and the surface and/or the fibers previously laid.

According to an alternative embodiment, the first lamp 3 is oriented in such a way as to also heat the nip area between the roller and the application surface, as well as possibly the part of the application surface or fibers previously laid which is just upstream of the roller.

FIGS. 5 and 6 illustrate an alternative embodiment in which the head is further equipped with a secondary guide system said lateral 7, making it possible to laterally guide the fibers coming out of the main guide system. This lateral secondary guide system is in the form of a comb, comprising a base 71 by which the comb is mounted on the head, the base bearing a plurality of fingers 72.

The fingers 72 are under the form of tabs or small plates, of small thickness, mounted parallel to one another on a bar forming the base 71, with a separation distance between two adjacent tabs corresponding substantially to the width of a fiber. The comb is mounted by its base on the support structure 13, so that the tabs are positioned between the roller 11 and the main guide system 12, their main plane surfaces positioned perpendicularly to the axis A1 of the roller, each fiber which comes out of a channel of the main guide system 12 passing between two adjacent tabs. The tabs extend substantially from the outlets of the channels of the main guide system up to rod 5. The tabs present on their free edge a notch in which rod 5 positions itself in the active position of the heating system. Each fiber is thus guided laterally between two tabs, the tabs preventing the lateral movement of the fibers parallel to the axis A1 of the roller. The thinner section of the tabs, namely their small thickness, forms a negligible screen to the radiation emitted by the first lamp.

In an alternative embodiment, the lateral main guide system comprises only the two outer tabs, of the aforementioned comb, referenced 72a and 72b, making it possible to laterally guide the outer fibers of a complete band, formed in this example of 16 fibers, the two tabs preventing a lateral movement of the band in a direction parallel to the axis of rotation of the roller.

Although the invention has been described in conjunction with several specific embodiments, it is obvious that it is in no way limited thereto and includes all technical equivalents of the described means as well as their combinations if they are within the scope of the invention.

1. Fiber application head for producing composite material parts, comprising
an application roller for the application of a band formed of one or more fibers onto an application surface,
a main guide system for guiding at least one fiber towards said application roller, and
a heating system capable of emitting a thermal radiation in the direction of the band, just before application by the roller,
wherein the heating system comprises
at least one first infrared lamp capable of beating the band between its outlet from the main guide system and the contact area between the application roller and the application surface, and
at least one second infrared lamp capable of heating, upstream of the roller, the application surface and/or one or more previously applied bands,
said head further comprising a secondary guide system capable of guiding the band between the main guide system and the application roller while allowing said band to be heated by the first lamp between the main guide system and the application roller.

2. The fiber application head according to claim 1, wherein said secondary guide system is capable of laterally guiding said band coming out of the main guide system.

3. A head according to claim 2, wherein said guide system comprises a comb whose fingers extend substantially perpendicularly to the rotation axis (A1) of the application roller.

4. A head according to claim 3, wherein each fiber of the band is capable of being guided between two fingers of the comb.

5. A head according to claim 3, wherein said comb comprises only two fingers between which the band is guided.

6. A head according to claim 1, wherein said secondary guide system is capable of holding the band remote from the first lamp to avoid the contact of the band with the first lamp,

7. A head according to claim 6, wherein said secondary guide system comprises at least one rod positioned between the first lamp and the application roller substantially parallel to the axis of the roller, the band passing between said rod and the application roller.

8. A head according to claim 5, wherein each finger of the comb is in contact with the rod.

9. A head according to claim 7, wherein said rod is hollow and is cooled by a fluid circulating in said rod.

10. A head according to claim 1, wherein the thermal radiation of each first lamp is centered towards the application roller, and the thermal radiation of the second lamp is centered towards the application surface upstream of the application roller.

11. A head according to claim 1, comprising a fiber placement head.

12. A method of producing a composite material part comprising the application of continuous fibers onto an application surface to form a preform comprising several plies of superimposed fibers in different orientations, each ply being made by the application of one or more bands along one orientation, each band being formed from one or more fibers, wherein the application of fibers is carried out by means of a fiber application head according to claim 1, by relative movement of the application head in relation to the layup surface along different lay up trajectories.
